(19) United States
(12) Patent Application Publication
(10) Pub. No.: US 2026/0030546 A1
(43) Pub. Date: Jan. 29, 2026

(54) REINFORCEMENT LEARNING

(71) Applicant: Nokia Solutions and Networks Oy, Espoo (FI)

(72) Inventors: Dario BEGA, Stuttgart (DE); Borislava GAJIC, Munich (DE)

(21) Appl. No.: 18/997,741

(22) PCT Filed: Aug. 5, 2022
(86) PCT No.: PCT/EP2022/072047

§ 371 Date: Jan. 22, 2025

(51) Int. Cl. G06N 20/00

(52) U.S. Cl. CPC G06N 20/00

(57) ABSTRACT

Method comprising: monitoring whether a MTLF receives a first state of an environment on which a RL training is to be performed; performing a ML model forward propagation on a first model of the environment having the first state for each of plural actions to obtain a respective expected reward for each of the plural actions: informing a service consumer on the plural actions and their respective expected reward; supervising whether the MTLF receives a RL training result information after the informing the service consumer on the plural actions, wherein the RL training result information comprises an indication of one of the plural actions, a second state of the environment, and a reward feedback; conducting a ML model backward propagation on the first model of the environment having the second state for the one of the plural actions using the reward feedback to obtain a second model of the environment.

### FIELD OF THE INVENTION

The present disclosure relates to reinforcement learning.

### Abbreviations

3GPP 3rd Generation Partnership Project
5G/6G/7G 5th/6th/7th Generation
5GC 5G Core network
5GS 5G System
ACK Acknowledgement
ADRF Analytical Data Repository Function
AI Artificial Intelligence
AnLF Analytics Logical Function
ID Identifier
KPI Key Performance Indicator
MDAF Management Data Analytics Function
ML Machine Learning
MnS Management Service
MTLF Model Training Logical Function
NWDAF Network Data Analytics Function
OAM Operation, Administration, and Maintenance
RL Reinforcement Learning
SA System Architecture
TS Technical Specification
UE User Equipment

### BACKGROUND

Artificial Intelligence (AI) and Machine Learning (ML) techniques are being increasingly employed in 5G system (5GS) and are considered as a key enabler of 6G mobile network generation. NWDAF in 5G core (5GC) and MDAF in OAM bring intelligence and generate analytics by processing management and network data, and may employ AI and ML techniques.

The analytics consumer, based on the analytics/predictions/recommendation produced by the NWDAF/MDAF, takes actions that are enforced in the mobile network. Example of decisions may be handover of UEs, traffic steering, power-on/off of base stations, etc.

3GPP TS 23.288 defines the procedures of analytics and ML model provisioning, which provides the means to NWDAF Service Consumer (i.e. an NWDAF containing an AnLF-Analytics Logical Function) to request the model corresponding to specific analytics from NWDAF containing an MTLF-Model training Logical Function. The NWDAF containing the MTLF will determine for the requested Analytics ID whether an existing trained ML Model can be used or if triggering further training for an existing trained ML models is needed. Similarly, 3GPP TS 28.105 defines the procedures allowing the training consumer to request the training of the ML model by the training producer.

However, the aforementioned specifications mostly focus on supervised learning techniques in which an ML model is trained using a training dataset.

Reinforcement learning technique is a type of ML algorithm in which an agent interacts with the environment in order to learn the policy that optimizes an objective function. In order to train a reinforcement learning algorithm the agent takes an action and enforces it in the environment, receives a reward as a feedback for the action taken, and is aware of the environment state before and after taking the action. During the training phase, the agent, for the sake of exploring the state space for devising the optimal policy, usually selects the action with the highest expected reward, but may sometimes select a “wrong” action (i.e., an action related with lower expected reward). This is known as exploration vs exploitation strategy and is fundamental to successfully train an RL agent.

In some cases (e.g. in some policy gradient RL algorithms), a reward for a certain action may be expressed as a probability to select the action. That is, in such cases, the reward is normalized to a value between 0 and 1.

### SUMMARY

It is an object of the present invention to improve the prior art.

According to a first aspect of the invention, there is provided an apparatus comprising:
one or more processors and memory storing instructions that, when executed by the one or more processors, cause the apparatus to perform:
monitoring whether a service consumer receives, from a service producer, an indication of an action which the service consumer may enforce on an environment in an reinforcement learning training process;
enforcing the action on the environment if the service consumer receives the indication of the action;
informing the service producer that the action is enforced if the action is enforced.

According to a second aspect of the invention, there is provided an apparatus comprising:
one or more processors and memory storing instructions that, when executed by the one or more processors, cause the apparatus to perform:
monitoring whether an analytics logical function receives an indication from a model training logical function that a reinforcement learning training on an environment will be performed;
evaluating the environment to obtain a first state of the environment if the analytics logical function receives the indication that the reinforcement learning training on the environment will be performed;
informing the model training logical function on the first state of the environment;
supervising whether the analytics logical function receives an indication of a first action;
forwarding the indication of the first action to the service consumer if the analytics logical function receives the indication of the first action;
checking whether the analytics logical function receives an information that the service consumer enforced a second action on the environment in response to the forwarding the indication of the first action;
evaluating the environment to obtain a second state of the environment if the analytics logical function receives the information that the service consumer enforced the second action on the environment;
informing the model training logical function on the second state of the environment.

According to a third aspect of the invention, there is provided an apparatus comprising:
one or more processors and memory storing instructions that, when executed by the one or more processors, cause the apparatus to perform:
monitoring whether a model training logical function receives a first state of an environment on which a reinforcement learning training is to be performed;
performing a machine learning model forward propagation on a first model of the environment having the first state for each of plural actions to obtain a respective expected reward for each of the plural actions if the model training logical function receives the first state of the environment;
informing a service consumer on the plural actions and their respective expected reward;
supervising whether the model training logical function receives a reinforcement learning training result information after the informing the service consumer on the plural actions, wherein the reinforcement learning training result information comprises an indication of one of the plural actions, a second state of the environment, and a reward feedback;
conducting a machine learning model backward propagation on the first model of the environment having the second state for the one of the plural actions using the reward feedback to obtain a second model of the environment if the model training logical function receives the reinforcement learning training result information.

According to a fourth aspect of the invention, there is provided an apparatus comprising:
one or more processors and memory storing instructions that, when executed by the one or more processors, cause the apparatus to perform:
monitoring whether a model training logical function receives a first state of an environment on which a reinforcement learning training is to be performed;
performing machine learning model forward propagation on a first model of the environment having the first state for each of plural actions to obtain a respective expected reward for each of the plural actions if the model training logical function receives the first state of the environment;
selecting a first one of the plural actions taking into account the expected rewards;
informing a service consumer on the first one of the plural actions;
supervising whether the model training logical function receives a reinforcement learning training result information after the informing the service consumer on the first one of the plural actions, wherein the reinforcement learning training result information comprises a second state of the environment, a reward feedback, and an indication of a second action;
conducting a machine learning model backward propagation on the first model of the environment having the second state for the second action and the reward feedback to obtain a second model of the environment if the model training logical function receives the reinforcement learning training result information.

According to a fifth aspect of the invention, there is provided a method comprising:
monitoring whether a service consumer receives, from a service producer, an indication of an action which the service consumer may enforce on an environment in an reinforcement learning training process;
enforcing the action on the environment if the service consumer receives the indication of the action;
informing the service producer that the action is enforced if the action is enforced.

According to a sixth aspect of the invention, there is provided a method comprising:
monitoring whether an analytics logical function receives an indication from a model training logical function that a reinforcement learning training on an environment will be performed;
evaluating the environment to obtain a first state of the environment if the analytics logical function receives the indication that the reinforcement learning training on the environment will be performed;
informing the model training logical function on the first state of the environment;
supervising whether the analytics logical function receives an indication of a first action;
forwarding the indication of the first action to the service consumer if the analytics logical function receives the indication of the first action;
checking whether the analytics logical function receives an information that the service consumer enforced a second action on the environment in response to the forwarding the indication of the first action;
evaluating the environment to obtain a second state of the environment if the analytics logical function receives the information that the service consumer enforced the second action on the environment;
informing the model training logical function on the second state of the environment.

According to a seventh aspect of the invention, there is provided a method comprising:
monitoring whether a model training logical function receives a first state of an environment on which a reinforcement learning training is to be performed;
performing a machine learning model forward propagation on a first model of the environment having the first state for each of plural actions to obtain a respective expected reward for each of the plural actions if the model training logical function receives the first state of the environment;
informing a service consumer on the plural actions and their respective expected reward;
supervising whether the model training logical function receives a reinforcement learning training result information after the informing the service consumer on the plural actions, wherein the reinforcement learning training result information comprises an indication of one of the plural actions, a second state of the environment, and a reward feedback;
conducting a machine learning model backward propagation on the first model of the environment having the second state for the one of the plural actions using the reward feedback to obtain a second model of the environment if the model training logical function receives the reinforcement learning training result information.

According to an eighth aspect of the invention, there is provided a method comprising:
monitoring whether a model training logical function receives a first state of an environment on which a reinforcement learning training is to be performed;
performing machine learning model forward propagation on a first model of the environment having the first state for each of plural actions to obtain a respective expected reward for each of the plural actions if the model training logical function receives the first state of the environment;
selecting a first one of the plural actions taking into account the expected rewards;
informing a service consumer on the first one of the plural actions;
supervising whether the model training logical function receives a reinforcement learning training result information after the informing the service consumer on the first one of the plural actions, wherein the reinforcement learning training result information comprises a second state of the environment, a reward feedback, and an indication of a second action;
conducting a machine learning model backward propagation on the first model of the environment having the second state for the second action and the reward feedback to obtain a second model of the environment if the model training logical function receives the reinforcement learning training result information.

Each of the methods of the fifth to eighth aspects may be a method of reinforcement learning.

According to a ninth aspect of the invention, there is provided a computer program product comprising a set of instructions which, when executed on an apparatus, is configured to cause the apparatus to carry out the method according to any of the fifth to eighth aspects. The computer program product may be embodied as a computer-readable medium or directly loadable into a computer.

According to some embodiments of the invention, at least one of the following advantages may be achieved:
RL training may be performed in communication networks; or
the existing architecture may be exploited; or
sensitive information may be hidden.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 (comprising FIGS. 1A and 1B) shows a message sequence chart according to some example embodiments of the invention;

FIG. 2 (comprising FIGS. 2A and 2B) shows a message sequence chart according to some example embodiments of the invention;

FIG. 3 (comprising FIGS. 3A and 3B) shows a message sequence chart according to some example embodiments of the invention;

FIG. 4 shows a message sequence chart according to some example embodiments of the invention;

FIG. 5 shows a message sequence chart according to some example embodiments of the invention;

FIG. 6 shows an apparatus according to an example embodiment of the invention;

FIG. 7 shows a method according to an example embodiment of the invention;

FIG. 8 shows an apparatus according to an example embodiment of the invention;

FIG. 9 shows a method according to an example embodiment of the invention;

FIG. 10 shows an apparatus according to an example embodiment of the invention;

FIG. 11 shows a method according to an example embodiment of the invention;

FIG. 12 shows an apparatus according to an example embodiment of the invention;

FIG. 13 shows a method according to an example embodiment of the invention; and

FIG. 14 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Current 3GPP specifications do not define enablers and information to be exchanged between a service producer and a service consumer in order to successfully train a RL model. To enable the training of an RL model in a mobile network, some information may have to be exchanged and new collaborative mechanisms between consumer and producer may be introduced because training information according to current 3GPP standards might not be sufficient for RL training.

Furthermore, current 3GPP specifications do not cover some RL scenarios where consumer and producer may belong to different parties (e.g., vendor and operator) that might not want to disclose potentially sensitive information (such as reward function or model architecture) to the other party.

Some example embodiments of the invention provide a collaborative mechanism for information exchange between producer and consumer to enable the training of reinforcement learning (RL) model. Specifically, some example embodiments of the invention provide at least one of the following:
Collaborative interactions between consumer and producer for training RL model. The collaborative interactions are provided for different use cases (highlighting the role of the producer and consumer in each of them) including cases in which producer and consumer belong to different parties. Thus, the collaborative interactions allow for multi-vendor scenarios; or
Information to be exchanged between consumer and producer in order to allow training of RL model. These pieces of information may include e.g.:
Action recommendation
Action selected
Environment state
Reward for taking an action at a given time in a given environment state; or
Information related to List of Analytics ID (may be specified in 3GPP TS23.288), such as:
Available ML methods for requested Analytics ID.
List of actions associated with Analytics ID.
List of KPIs, counters, measurements, network element state that can be used to describe the environment for the requested Analytics ID.

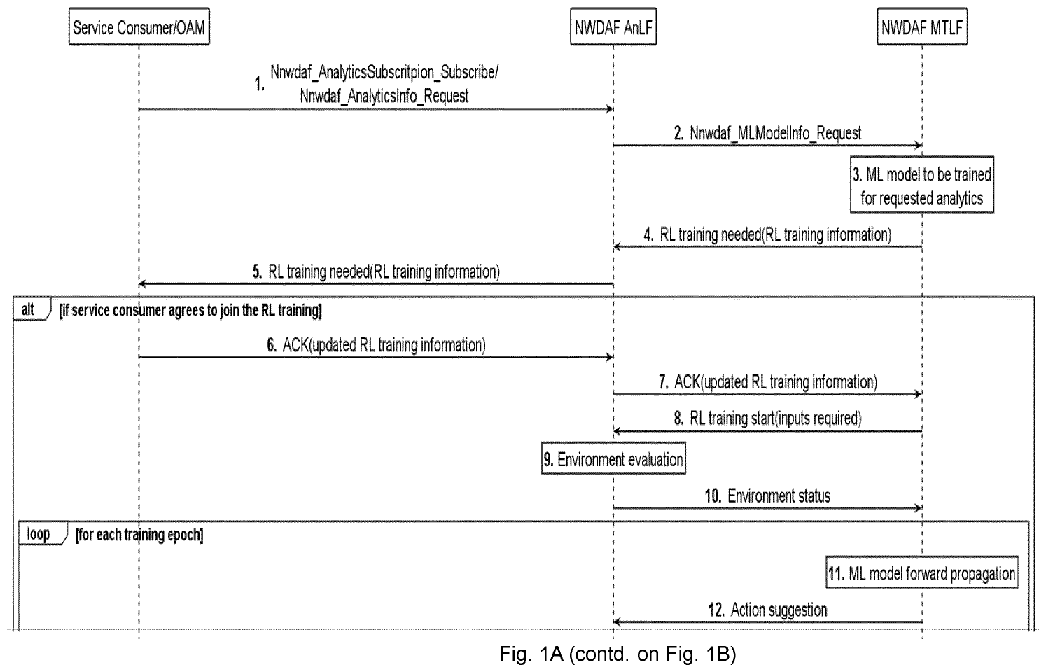

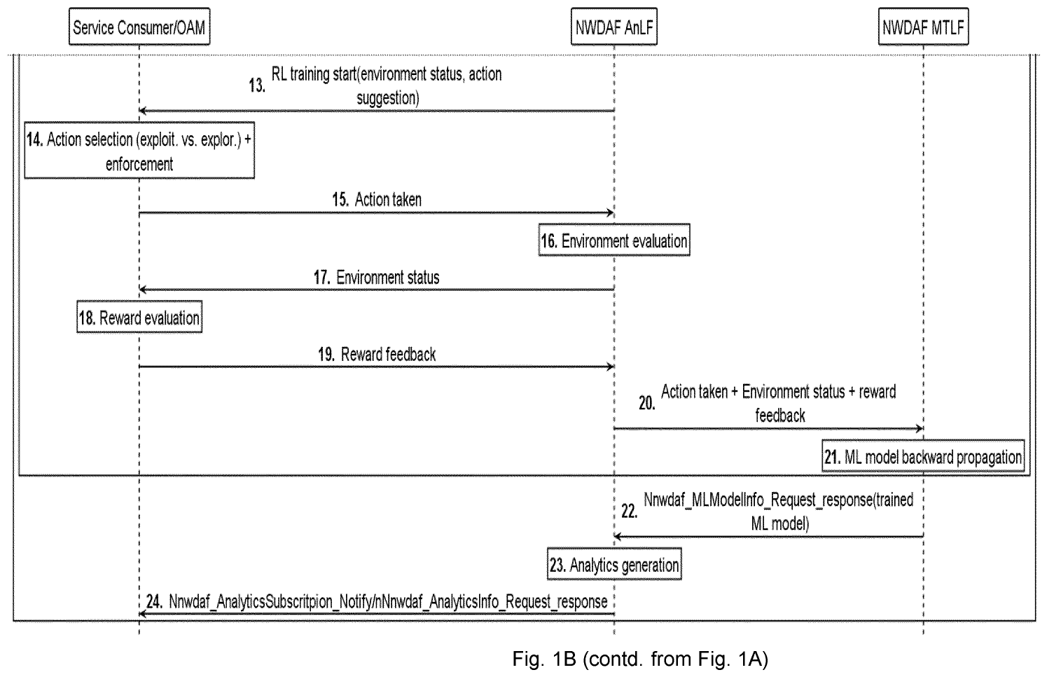

Message exchanges and related actions and information exchange according to some example embodiments of the invention are explained at greater detail hereinafter with reference to FIGS. 1 to 5. Example embodiments 1 to 3 are described in a SA2 context (Study of Enablers for Network Automation for 5G), example embodiments 4 and 5 are described in a SA5 context (Study on AI/ML management). In example embodiments 1 to 3, the service producer (here: NWDAF, but may be MDAF instead, for example) is functionally split into (NWDAF) AnLF and (NWDAF) MTLF, and the message exchange between AnLF and MTLF is described, too. However, in some example embodiments, the service producer may be a single function.

### Example Embodiment 1: Explor. Vs Exploit.+Reward Evaluation at Consumer Side

In this example embodiment (shown in FIG. 1), the service consumer is responsible for applying the exploration vs exploitation strategy (i.e., to select sometimes not the action related with the best expected reward, but one of the other actions. For example, the service consumer may select the action randomly or based on some internal metric (such as entropy). Furthermore, the service consumer evaluates the network state (compares the network state before and after the action is enforced) and derives the reward obtained due to the selected action based on the comparison.

The actions shown in FIG. 1 are as follows:
1. Service consumer subscribes to or requests analytics from NWADF AnLF.
2. NWDAF AnLF requests a model from NWDAF MTLF for providing the requested analytics.
3. NWDAF MTLF detects that ML model training is needed since a trained ML model is not available for producing the requested analytics. Based on the Analytics ID, MTLF may detect that RL techniques may be used. For example, MTLF may know, for each Analytics ID, a list of ML approaches that could be utilized to produce the requested analytics. Such a relationship may be available to the service producer (MTLF) in the other example embodiments, too.
4. NWDAF MTLF informs AnLF that the training of a model is needed and that the model should be trained following RL approach. Typically, this approach requires the involvement of the service consumer who should accept to join the RL training phase. Accordingly, the MTLF forwards to the AnLF the information about the RL algorithm, i.e., the set of actions (the action space) for the requested Analytics ID, the required inputs, i.e., the information needed to successfully model the environment (this may include one or more KPIs, counters, measurements, network element state, etc). This information is typically use case specific. In addition, MTLF may propose an exploration vs exploitation strategy. This information is summarized as “RL training information”.
5. NWDAF AnLF sends to the service consumer the request to join the RL training phase of the RL algorithms. This includes the RL training information.
6. If the service consumer accepts to join the RL training phase, it informs the AnLF with an ACK message. The service consumer may also propose to modify the RL training information.
7. The AnLF informs the MTLF about the acceptance by the service consumer to join the RL algorithm training.
8. NWDAF MTLF informs AnLF about the starting of the training process.
9. AnLF collects the required data to capture the environment state (first state). Capturing the state of the environment may include data collection and analytics production.
10. AnLF provides to the MTLF the information about the current environment state.
11. MTLF runs a forward propagation of the ML model using as inputs the current environment state, and producing as output an actions recommendation which may typically comprise plural actions. For each of the actions, an expected reward will be indicated in the actions recommendation.
12. MTLF forwards to AnLF the actions recommendation, i.e., the possible actions that could be taken along with the expected reward associated to them.
13. AnLF provides the current environment state and the actions recommendation produced by MTLF. AnLF informs the service consumer that the RL training process started. This information may be explicit or implicit by providing the current environment state and the actions recommendation.
14. The service consumer, based on the current environment state and the actions recommendation, selects and enforces an action on the environment. The action selection is performed by applying exploration vs exploitation strategy, i.e. selecting not always the action related with the highest expected reward.
15. The service consumer informs AnLF about the action selected and enforced.
16. AnLF evaluates the new environment state (second state) as in action 9.
17. AnLF forwards to the service consumer the new environment state.
18. The service consumer derives the reward obtained by enforcing the action selected in action 14 by comparing the new environment state (second state) with the previous one (first state, before the action was enforced).
19. The service consumer sends to the AnLF a reward feedback. The reward feedback may comprise the derived reward. However, in some example embodiments, the reward feedback may differ from the derived reward. For example, the reward feedback may be obtained by a mapping from the derived reward to one of plural predefined reward feedbacks (e.g., the reward feedback could +1 in case of a good action impact, −1 in case of bad action impact, and 0 in case the action enforced did not substantially impact the environment). A reason for such mapping may be that the reward function may contain sensitive information that a service consumer may be not willing to expose to the service producer.
20. AnLF forwards to MTLF the action selected, the new environment state (second state) along with the reward feedback.
21. MTLF performs a backward propagation to train the ML model in order to optimize the objective function. Actions 11 to 21 are repeated for the whole training loop.
22. Once the trained loop is over because the ML model has been successfully trained (according to some exit criterion at the MTLF), the MTLF forwards to AnLF the trained ML model.
23. AnLF runs the trained ML model to produce the requested analytics.
24. AnLF forwards to the service consumer the requested analytics.

In some example embodiments, actions 7 and 8 may be omitted, and AnLF provides the environment evaluation (action 9) when it receives the ACK from the service consumer in action 6. That is, in such example embodiments, MTLF may understand the receipt of the environment evaluation (action 9) as an implicit ACK from the service producer.

In some example embodiments, actions 5 to 8 may be omitted. Instead AnLF provides the environment evaluation (action 9) in response to receiving the information that a RL training will be performed (action 4). For example, AnLF may know that the service consumer agrees to joining the RL training from some previous message exchange, or because the agreement of the service consumer is predefined in AnLF for the service consumer. Also, in some example embodiments, the agreement or non-agreement by the service consumer may be considered as irrelevant.

### Example Embodiment 2: Explor. Vs Exploit. At Producer Side, Reward Evaluation at Consumer Side

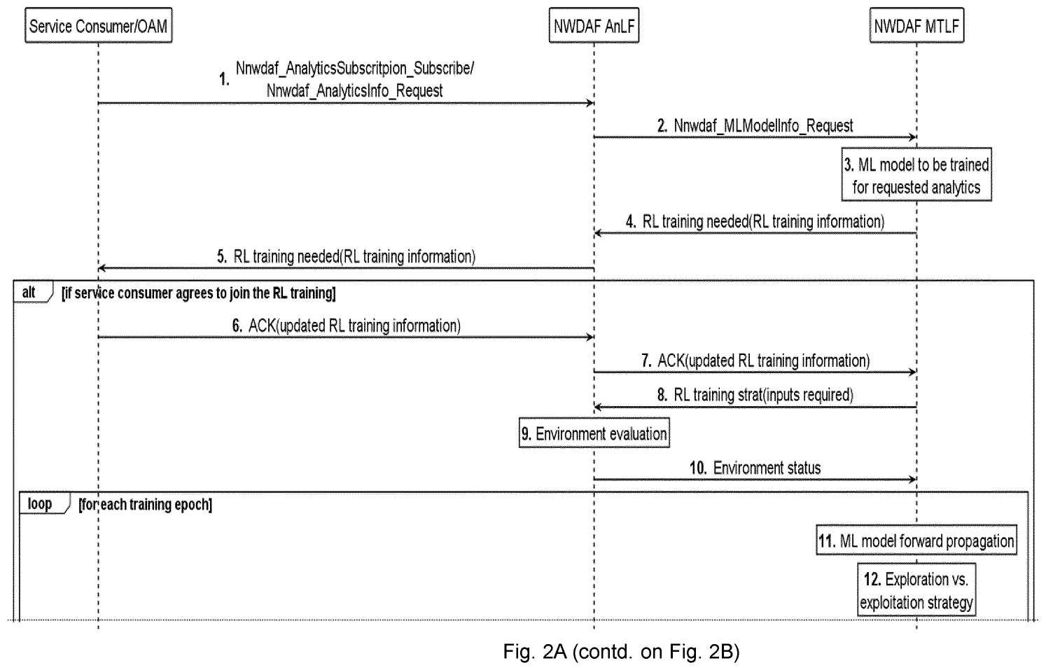

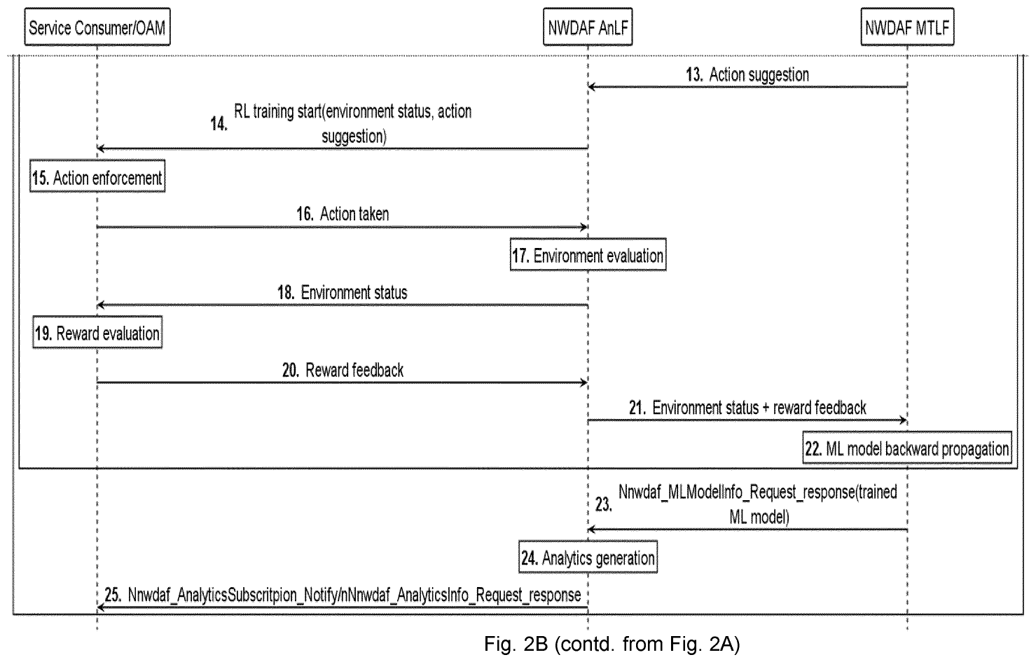

In this example embodiment (shown in FIG. 2), the producer, i.e., MTLF, is responsible for applying the exploration vs. exploitation technique, while the consumer derives the reward resulting from the action enforced in the mobile network. This option may be suitable e.g. for a multi-vendor use case and/or when the reward function is based on sensitive information, such as charging. In this case the consumer may derive the reward by using its internal reward function and just provides to the producer a reward feedback, which may be generated by a mapping from the result of the reward function to one of plural predefined feedback values.

The actions shown in FIG. 2 are as follows:

Actions 1 to 11: See actions 1 to 11 of Example Embodiment 1 (FIG. 1). In example embodiment 2, RL training information may not include any exploration vs exploitation strategy. Also, as discussed with example embodiment 1, actions 7 and 8 or actions 5 to 8 may be omitted.
12. MTLF selects an action among the ones returned by the ML model in action 11, and applies the exploration vs exploitation strategy. I.e., MTLF selects one of the actions taking into account the expected reward, but sometimes it does not select the action related with the highest expected reward.
13. MTLF forwards to AnLF the action selected.
14. AnLF forwards the current environment state and the action to be enforced. Thus, AnLF informs the service consumer (implicitly) that the RL training started. AnLF may inform the service consumer explicitly that the RI training started.
15. The service consumer enforces the action selected by the MTLF in the mobile network.
16. The service consumer informs AnLF that the action has been successfully enforced and from this point in time, it could expect changes in the environment.
17. The AnLF evaluates the new environment state (second state).
18. The AnLF forwards to the service consumer the new environment state (second state).
19. The consumer knowing the former and the new environment state (first and second states), evaluates the impact of the enforced action using its internal reward function. Thus, the consumer derives a reward of the enforced action.
20. The service consumer sends to the AnLF the reward feedback (which may be either the reward or derived from the reward by a mapping to some predefined feedback values).
21. The AnLF forwards to the MTLF the new environment state (second state) and the reward feedback received from the service consumer.

Actions 22 to 25: See Actions 21 to 24 of Example Embodiment 1 (FIG. 1).

### Example Embodiment 3: Explor. Vs Exploit. And Reward Evaluation at Producer Side

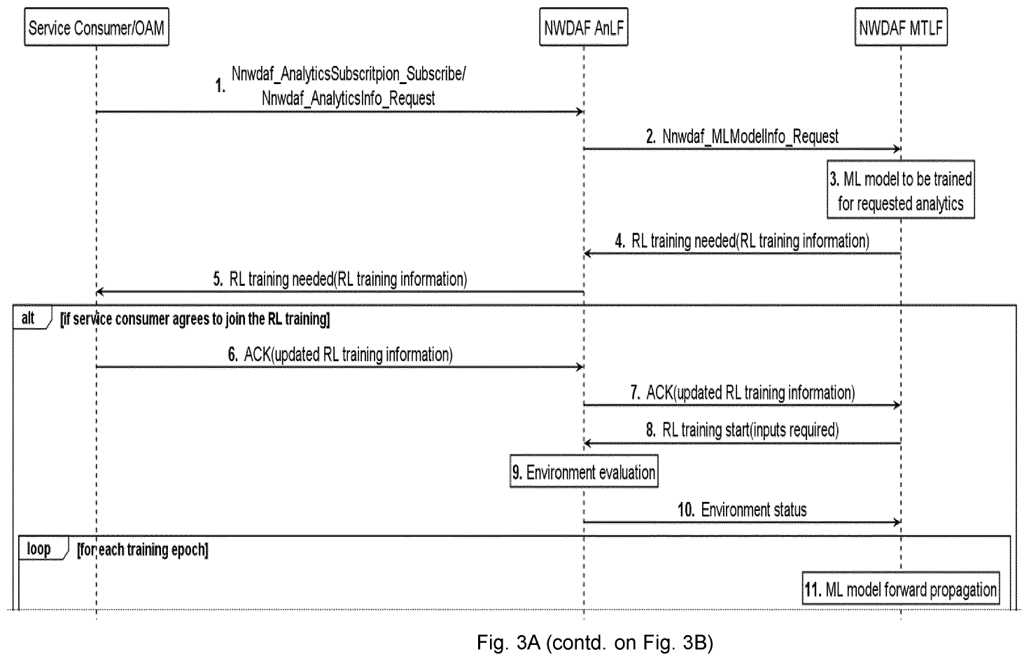

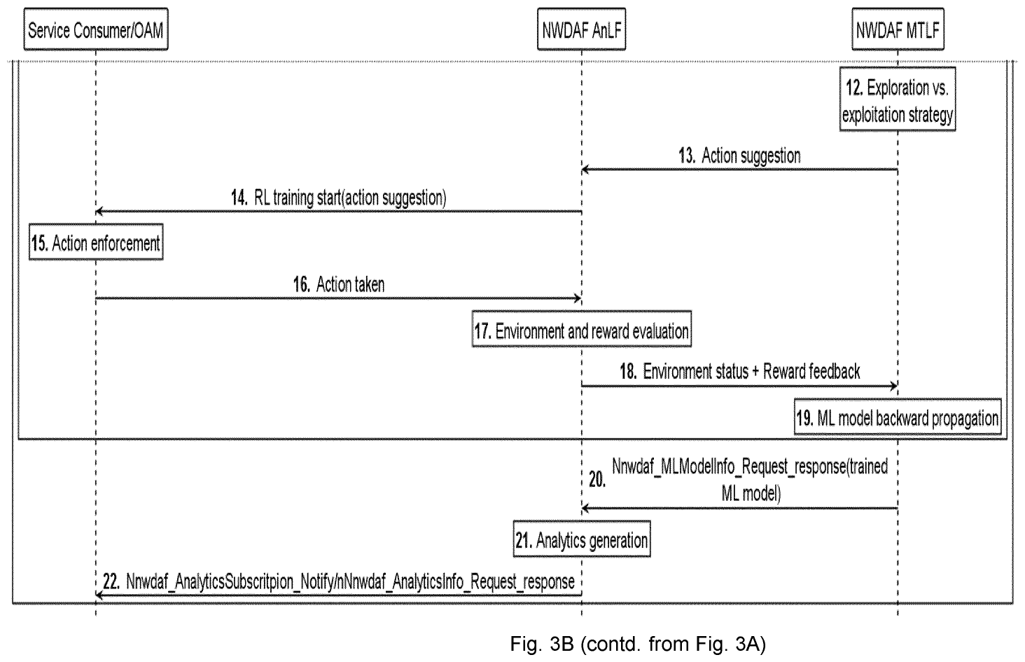

In this example embodiment (shown in FIG. 3), the producer is responsible to apply exploration vs exploitation strategy and to derive the reward resulting from the enforced action. This example embodiment may be applied in particular in case the action impact is based only on mobile network related metrics, such as KPIs, counters, etc., that can be collected and evaluated by NWDAF.

The actions shown in FIG. 3 are as follows:

Actions 1 to 3: See actions 1 to 3 of Example Embodiment 1 (FIG. 1).
4. NWDAF MTLF informs AnLF that the training of a model is needed and that the model should be trained following RL approach. Typically, this approach requires the involvement of the service consumer who should accept to join the RL training phase. Accordingly, the MTLF forwards to the AnLF the information about the RL algorithm, i.e., the set of actions (the action space) for the requested Analytics ID, the required inputs, i.e., the information needed to successfully model the environment (this may include one or more KPIs, counters, measurements, network element state, etc). This information is typically use case specific. In this example embodiment, the information includes also a metrics how to evaluate the action impact. This may be useful e.g. if the reward function is just mobile network related. In this way, the AnLF is informed about the metrics on which it should evaluate the action. The evaluation metrics may depend on the use case.

Actions 5 to 13. See actions 5 to 13 of Example Embodiment 2 (FIG. 2). As explained with respect to Example Embodiments 1 and 2, actions 7 and 8 or actions 5 to 8 may be omitted in some example embodiments.
14. AnLF forwards the action to be enforced to the service consumer. Thus, AnLF informs the service consumer (implicitly) that the RL training started. AnLF may inform the service consumer explicitly that the RL training started. Since the service consumer does not derive the reward, the service consumer is not interested in receiving the environment state. Thus, action 14 typically does not forward the environment state to the service consumer.

Actions 15 to 16: See actions 15 to 16 of Example Embodiment 2 (FIG. 2).
17. The AnLF evaluates the new environment state (second state) and the enforced action impact based on the metrics provided by MTLF in action 4. Based on this evaluation (comparison), AnLF derives a reward, and may derive a reward feedback by mapping of the derived reward to some predefined feedback values, as described for example embodiments 1 and 2.

Actions 18 to 22: See actions 21 to 25 of Example Embodiment 2 (FIG. 2).

In a further example embodiment (not shown in any of the figures), the reward is derived by AnLF, and the service consumer applies the exploration vs exploitation strategy. This example embodiment may be derived straightforward from the Example Embodiments 1 to 3.

The functional splitting of the service producer (e.g. NWDAF) into AnLF and MTLF with their respective tasks as shown in FIGS. 1 to 3 is typical but not mandatory. E.g., in some example embodiments, MTLF may perform the reward evaluation. In some example embodiments, the MTLF may not provide a exploration vs. exploitation strategy. Instead, the AnLF may provide this strategy, or this strategy may be predefined in the service consumer or known by the consumer due to some previous message exchange with the service producer.

### Example Embodiment 4: Explor. Vs Exploit. At Producer Side, Reward Evaluation at Consumer Side

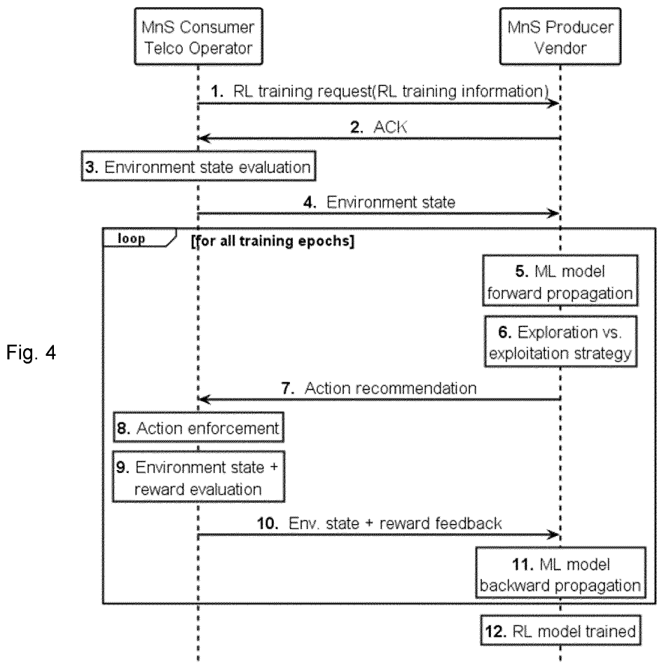

In this example embodiment (shown in FIG. 4), the exploration vs exploitation strategy is applied by the MnS producer. In this scenario, the MnS consumer (e.g. a telco operator), requests from the MnS producer (e.g. a vendor) an RL solution.

The actions shown in FIG. 4 are as follows:
1. The MnS Consumer requests from the MnS producer the training of an RL solution. In the request, the MnS Consumer specifies the RL training information as the state and action space and the exploration vs exploitation strategy to be applied. The state space, i.e., the environment representation, may depend on the use case and could include e.g. one or more KPIs, counters, network entities state, trace jobs, etc., The action space may depend on the use case. For example, there may be a predefined list of actions related with each use case.
2. The MnS Producer acknowledges the request from the MnS consumer.
3. The MnS consumer evaluates the current environment state. In the present example embodiment, it is assumed that MnS consumer can evaluate the mobile network state (environment state) and enforce actions in the environment. For example, this assumption is typically valid if the MnS consumer is a telco operator.
4. The MnS consumer forwards the current environment state to the MnS producer.
5. For each epoch of the training loop, the MnS producer performs a RL model forward propagation step using as input the current environment state. The result of the forward propagation step is an expected reward related with each action.
6. The MnS producer applies the exploration vs. exploitation strategy selecting sometimes not the action related with the highest expected reward.
7. The MnS producer sends to the consumer the selected action to be enforced in the environment (e.g. mobile network).
8. The MnS Consumer enforces the action.
9. The consumer evaluates the new environment state and the action impact in terms of its internal reward function to obtain a reward. Thus, the consumer measure if, based on its internal metric, the action had a good or bad impact.
10. The consumer sends to the producer the new environment state and a reward feedback. As discussed above, the reward feedback may be the same as the reward or may be derived from the reward by mapping on one of plural predefined feedback values. For example, the consumer may provide a mapping as feedback (e.g., +1 if the action had a good impact, −1 if it had a bad impact, 0 if no change in the environment state). The mapping is particularly useful if the reward function is a sensitive information or depends on some sensitive information.
11. The MnS producer performs a RL model backward propagation step to train the RL model.
12. At the end of the loop, the producer has successfully trained the RL model. For example, the trained model may now be employed to produce a desired analytics.

### Example Embodiment 5: Explor. Vs Exploit. At Consumer Side

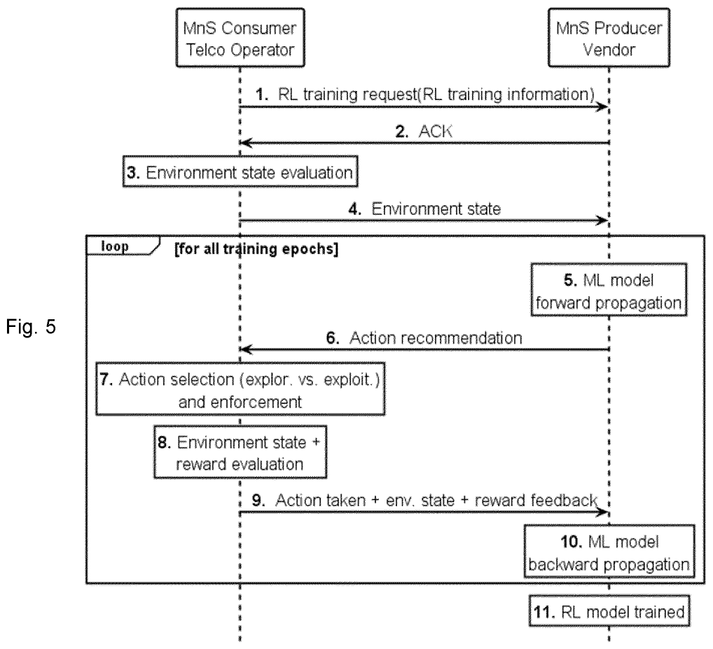

This example embodiment (shown in FIG. 5) is a variant version of the Example Embodiment 4. In this example embodiment, the exploitation vs exploration strategy is applied at the consumer side.

The actions shown in FIG. 5 are as follows:

1 to 5: See actions 1 to 5 of Example Embodiment 4. In this option, the RL training information may not include the exploration vs exploitation strategy.
6. The MnS producer sends to the consumer the output generated by action 5, i.e., the expected reward related with each action given the current environment state.
7. The MnS consumer, applying the exploration vs exploitation strategy, selects and enforces one of the actions.
8. See action 9 of Example Embodiment 4.
9. The MnS consumer sends to the producer the action selected and enforced, the new environment state and the reward feedback.
10 to 11: See actions 11 to 12 of Example Embodiment 4.

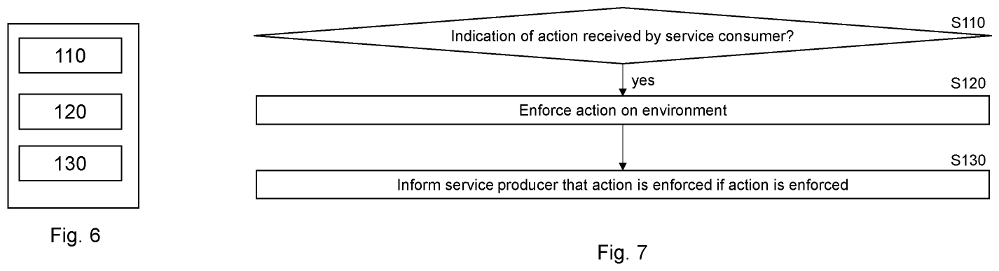

FIG. 6 shows an apparatus according to an example embodiment of the invention. The apparatus may be a service consumer (such as a telco operator) or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for monitoring 110, means for enforcing 120, and means for informing 130. The means for monitoring 110, means for enforcing 120, and means for informing 130 may be a monitoring means, enforcing means, and informing means, respectively. The means for monitoring 110, means for enforcing 120, and means for informing 130 may be a monitor, enforcer, and informer, respectively. The means for monitoring 110, means for enforcing 120, and means for informing 130 may be a monitoring processor, enforcing processor, and informing processor, respectively.

The means for monitoring 110 monitors whether a service consumer receives, from a service producer, an indication of an action (S110). The service consumer may enforce the action on an environment in an RL training process.

If the service consumer receives the indication of the action (S110=yes), the means for enforcing 120 enforces the action on the environment (S120). If the action is enforced in S120, the means for informing 130 informs the service producer that the action is enforced (S130).

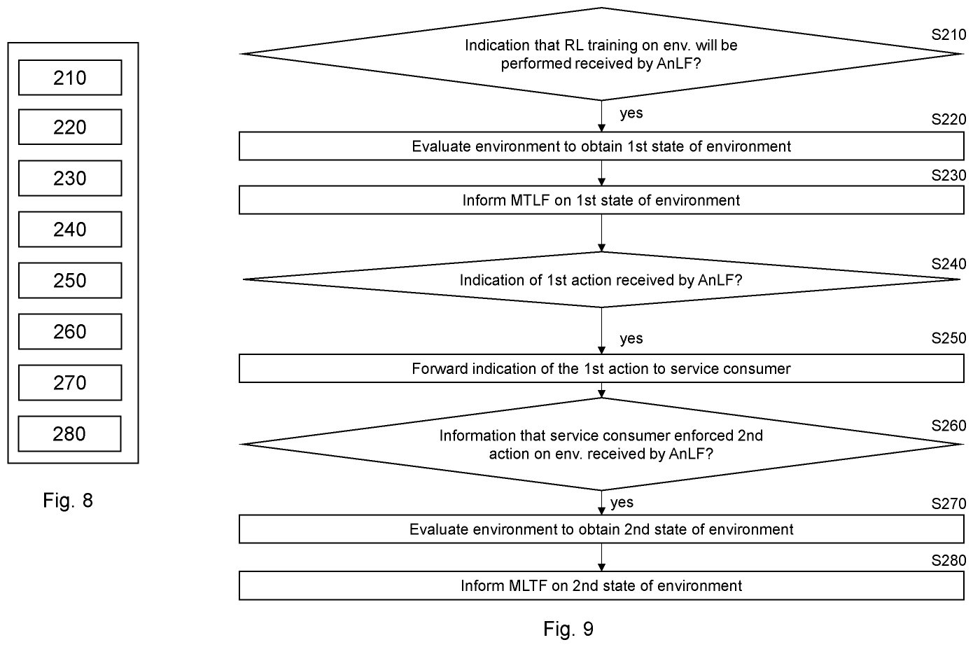

FIG. 8 shows an apparatus according to an example embodiment of the invention. The apparatus may be a service producer (such as a NWDAF or a MDAF) or a functional part of the service producer (such as a AnLF) or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for monitoring 210, first means for evaluating 220, first means for informing 230, means for supervising 240, means for forwarding 250, means for checking 260, second means for evaluating 270, and second means for informing 280. The first means for monitoring 210, first means for evaluating 220, means for informing 230, means for supervising 240, means for forwarding 250, means for checking 260, second means for evaluating 270, and second means for informing 280 may be a monitoring means, first evaluating means, first informing means, supervising means, forwarding means, checking means, second evaluating means, and second informing means, respectively. The first means for monitoring 210, first means for evaluating 220, means for informing 230, means for supervising 240, means for forwarding 250, means for checking 260, second means for evaluating 270, and second means for informing 280 may be a monitor, first evaluator, first informer, supervisor, forwarder, checker, second evaluator, and second informer, respectively. The means for monitoring 210, first means for evaluating 220, first means for informing 230, means for supervising 240, means for forwarding 250, means for checking 260, second means for evaluating 270, and second means for informing 280 may be a monitoring processor, first evaluating processor, first informing processor, supervising processor, forwarding processor, checking processor, second evaluating processor, and second informing processor, respectively.

The means for monitoring 210 monitors whether an AnLF receives an indication from a MTLF that a RL training on an environment will be performed (S210). If the AnLF receives the indication that the RL training on the environment will be performed (S210=yes), the first means for evaluating 220 evaluates the environment to obtain a first state of the environment (S220). The first means for informing 230 informs the MTLF on the first state of the environment (S230).

The means for supervising 240 supervises whether the AnLF receives an indication of a first action (S240). The first action should be an action which a service consumer may enforce on the environment. If the AnLF receives the indication of the first action (S240=yes), the means for forwarding 250 forwards the indication of the first action to the service consumer (S250).

The means for checking 260 checks whether the AnLF receives, in response to the forwarding the indication of the first action (S250), an information that the service consumer enforced a second action on the environment (S260). If the AnLF receives the information that the service consumer enforced the second action on the environment (S260=yes), the second means for evaluating 270 evaluates the environment to obtain a second state of the environment (S270). The second means for informing 280 informs the MTLF on the second state of the environment (S280). The first action may be the same as the second action, or the first action may be different from the second action.

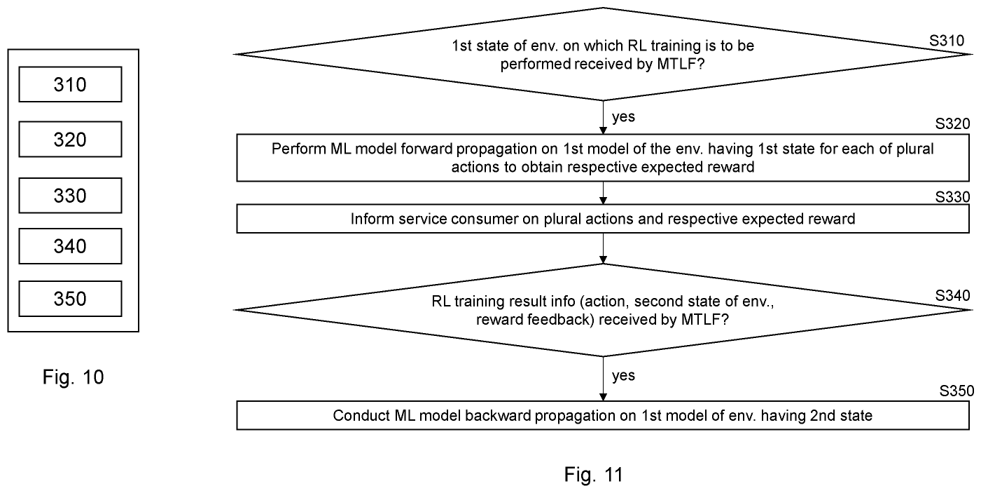

FIG. 10 shows an apparatus according to an example embodiment of the invention. The apparatus may be a service producer (such as a NWDAF or a MDAF) or a functional part of the service producer (such as a MTLF) or an element thereof. FIG. 11 shows a method according to an example embodiment of the invention. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises means for monitoring 310, means for performing 320, means for informing 330, means for supervising 340, and means for conducting 350. The means for monitoring 310, means for performing 320, means for informing 330, means for supervising 340, and means for conducting 350 may be a monitoring means, performing means, informing means, supervising means, and conducting means, respectively. The means for monitoring 310, means for performing 320, means for informing 330, means for supervising 340, and means for conducting 350 may be a monitor, performer, informer, supervisor, and conductor, respectively. The means for monitoring 310, means for performing 320, means for informing 330, means for supervising 340, and means for conducting 350 may be a monitoring processor, performing processor, informing processor, supervising processor, and conducting processor, respectively.

The means for monitoring 310 monitors whether a MTLF receives a first state of an environment on which a RL training is to be performed (S310). If the MTLF receives the first state of the environment (S310=yes), the means for performing 320 performs a ML model forward propagation on a first model of the environment having the first state for each of plural actions (S320). Thus, the means for performing 320 obtains a respective expected reward for each of the plural actions. The means for informing 330 informs a service consumer on the plural actions and their respective expected reward (S330).

The means for supervising 340 supervises whether the MTLF receives a RL training result information after the informing the service consumer on the plural actions of S330 (S340). The RL training result information comprises an indication of one of the plural actions, a second state of the environment, and a reward feedback. If the MTLF receives the RL training result information (S340=yes), the means for conducting 350 conducts a ML model backward propagation on the first model of the environment having the second state for the one of the plural actions using the reward feedback (S350). Thus, the means for conducting 350 obtains a second model of the environment.

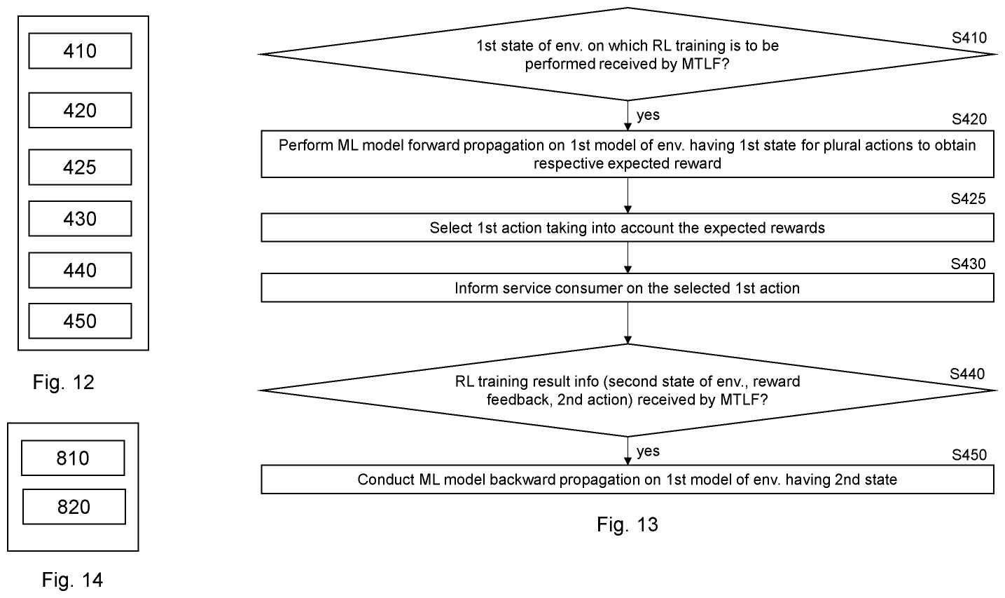

FIG. 12 shows an apparatus according to an example embodiment of the invention. The apparatus may be a service producer (such as a NWDAF or a MDAF) or a functional part of the service producer (such as a MTLF) or an element thereof. FIG. 13 shows a method according to an example embodiment of the invention. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises means for monitoring 410, means for performing 420, means for selecting 425, means for informing 430, means for supervising 440, and means for conducting 450. The means for monitoring 410, means for performing 420, means for selecting 425, means for informing 430, means for supervising 440, and means for conducting 450 may be a monitoring means, performing means, selecting means, informing means, supervising means, and conducting means, respectively. The means for monitoring 410, means for performing 420, means for selecting 425, means for informing 430, means for supervising 440, and means for conducting 450 may be a monitor, performer, selector, informer, supervisor, and conductor, respectively. The means for monitoring 410, means for performing 420, means for selecting 425, means for informing 430, means for supervising 440, and means for conducting 450 may be a monitoring processor, performing processor, selecting processor, informing processor, supervising processor, and conducting processor, respectively.

The means for monitoring 410 monitors whether a MTLF receives a first state of an environment on which a RL training is to be performed (S410). If the MTLF receives the first state of the environment (S410=yes), the means for performing 420 performs ML model forward propagation on a first model of the environment having the first state for each of plural actions (S420). Thus, the means for performing 420 obtains a respective expected reward for each of the plural actions.

The means for selecting 425 selects a first one of the plural actions taking into account the expected rewards (S425). The means for selecting 425 may apply an exploration vs. exploitation strategy. The means for informing 430 informs a service consumer on the first one of the plural actions, i.e. on the action selected in S425 (S430).

The means for supervising 440 supervises whether the MTLF receives a RL training result information after the informing the service consumer on the one of the plural actions in S430 (S440). The RL training result information comprises a second state of the environment, a reward feedback, and an indication of a second action. If the MTLF receives the RL training result information (S440=yes), the means for conducting 450 conducts a ML model backward propagation on the first model of the environment having the second state for the second action and the reward feedback (S450). Thus, the means for conduction 450 obtains a second model of the environment. The first one of the plural actions may be the same as the second action; or the first one of the plural actions may be different from the second action.

FIG. 14 shows an apparatus according to an example embodiment of the invention. The apparatus comprises at least one processor 810, at least one memory 820 storing instructions that, when executed by the at least one processor 810, cause the apparatus at least to perform the method according to at least one of the following figures and related description: FIG. 7 or FIG. 9 or FIG. 11 or FIG. 13.

Hereinabove, substantially a training process of RL training is described. Hereinafter, a complete example scenario including training phase and inference phase according to some example embodiments of the invention is described. The example scenario is related to deciding whether or not a handover is to be performed.

During the training phase of this example scenario, the following actions are performed:
0. The RL model is designed to get as input a list of data described below and to provide as output the expect rewards related to the action “perform handover” and to the action “do not perform handover”, respectively. The goal is to train the RL model to provide the right policy, i.e., which action is to be selected, given the actual environment status, in order to maximize the goal. In this example scenario, the goal may be avoiding undesired handovers while maximizing the QoS of the UE.
1. The RL model receives the input data (list of input data described in the example). The input data are representative of the current environment status (environment status includes both, UE's status and network's status).
2. The RL model uses the input data and provides as output the expected rewards related to both actions.
3. If the RL model producer is the one applying the exploration vs. exploitation strategy, then it selects one of the actions. When exploiting the policy, the agent selects the action related with the higher expected reward, otherwise the other action is selected. (As outlined hereinabove, the exploration vs. exploitation strategy may be applied by the service consumer instead)
4. The selected action enforced, thus the UE is handovered/not handovered.
5. Then, the consumer or the producer itself (depending on the options described hereinabove), provides to the RL model a feedback measuring the quality of the action taken.
6. Based on the feedback, the RL model is trained to then converge to the optimal policy, i.e., the action to be selected given the respective environment status. The convergence could be measured looking at the sum of the rewards collected and stopping once the total reward is stable.

During inference phase, the following actions may be performed:
1. Once the RL model is trained, it is ready to be used in inference. Inference may be performed by the producer of the training phase. Alternatively, the trained model may be transferred to some other device performing the inference. To start, the trained RL model receives the input data describing the environment status at inference time.
2. The RL model uses the input data and provides as output the expected rewards related to both actions.
3. The action related with the highest expected reward is selected and enforced. This time, no exploration is performed because the RL model is trained.
4. As an option, the feedback could be still collected to monitor the performance of the RL model.

For the example scenario, the input data describing the status of the environment may be one or more of the following:
Input information from the UE (such as UE location information interpreted by Gnb implementation when available; Radio measurements related to serving cell and neighboring cells associated with UE location information as RSRP, RSRQ, SINR; UE historical service cells and their locations; Moving velocity),
Input information from the neighboring RAN nodes (such as UE's successful handover information in the past and received from neighboring RAN nodes; UE's history information from neighbor; Position, resource status, QoS parameters of historical HO-ed UE; Resource status and utilization prediction/estimation; Information about the performance of handed over UEs; Resource status prediction), and
Input information from the local node (such as UE trajectory prediction output; local resources status prediction; current/predicted UE traffic).

Some example embodiments are explained with respect to a 3GPP network (e.g. a 5G network or a 6G network). However, the invention is not limited to 3GPP networks. It may be used in other communication networks allowing RL training, too. I.e., it may be used in non-3GPP mobile communication networks and wired communication networks, too. It may be used even outside from communication networks, e.g. in power grids. Accordingly, the environment may be a respective communication network or a power grid etc., or a respective portion thereof.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality. The same applies correspondingly to the terminal.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, an service consumer (such as a OAM or another management function) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a service producer (such as a NWDAF or a MDAF) or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

The terms “first X” and “second X” include the options that “first X” is the same as “second X” and that “first X” is different from “second X”, unless otherwise specified. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

1-44. (canceled)

45. Apparatus comprising:
one or more processors and memory storing instructions that, when executed by the one or more processors, cause the apparatus to perform:
monitoring whether a service consumer receives, from a service producer, an indication of an action which the service consumer may enforce on an environment in an reinforcement learning training process;
enforcing the action on the environment if the service consumer receives the indication of the action;
informing the service producer that the action is enforced if the action is enforced.

46. The apparatus according to claim 45, wherein
the indication of the action indicates plural actions which the service consumer may enforce on the environment and a respective expected reward for each of the plural actions; and the instructions, when executed by the one or more processors, further cause the apparatus to perform
selecting one of the plural actions taking into account the expected rewards if the service consumer receives the indication of the plural actions; wherein
the enforcing comprises enforcing the selected one of the plural actions on the environment.

47. The apparatus according to claim 45, wherein
the indication of the action comprises information on a first state of the environment; and the instructions, when executed by the one or more processors, further cause the apparatus to perform
supervising whether the service consumer receives, from the service producer after the enforcing the action, information on a second state of the environment;
comparing the first state and the second state if the service consumer receives the information on the second state;
deriving a reward feedback based on the comparison of the first state and the second state;
informing the service producer on the reward feedback.

48. The apparatus according to claim 45, wherein the instructions, when executed by the one or more processors, further cause the apparatus to perform
evaluating the environment to obtain a first state of the environment prior to the monitoring whether the service consumer receives the indication of the action;
informing the service producer on the first state of the environment prior to the monitoring whether the service consumer receives the indication of the action;
evaluating the environment to obtain a second state of the environment after the enforcing the action;
comparing the first state and the second state;
deriving a reward feedback based on the comparison of the first state and the second state;
informing the service producer on the reward feedback and the second state of the environment.

49. The apparatus according to claim 47, wherein the instructions, when executed by the one or more processors, cause the apparatus to perform the deriving the reward feedback
either by subjecting the comparison of the first state and the second state to a reward function to obtain a reward, wherein the reward is equal to the reward feedback;
or by subjecting the comparison of the first state and the second state to the reward function to obtain the reward and mapping the reward to a respective one of plural predefined values of the reward feedback.

50. The apparatus according to claim 45, wherein the instructions, when executed by the one or more processors, further cause the apparatus to perform
monitoring whether the service consumer receives a request to join the reinforcement learning training process;
deciding whether or not the service consumer joins the reinforcement learning training process if the request to join the reinforcement learning training process is received;
inhibiting the monitoring whether the service consumer receives the indication of the action if it is decided that the service consumer does not join the reinforcement learning training process.

51. The apparatus according to claim 50, wherein the instructions, when executed by the one or more processors, further cause the apparatus to perform
informing the service producer on a result of the deciding whether or not the service consumer joins the reinforcement learning training process.

52. Apparatus comprising:
one or more processors and memory storing instructions that, when executed by the one or more processors, cause the apparatus to perform:
monitoring whether an analytics logical function receives an indication from a model training logical function that a reinforcement learning training on an environment will be performed;
evaluating the environment to obtain a first state of the environment if the analytics logical function receives the indication that the reinforcement learning training on the environment will be performed;
informing the model training logical function on the first state of the environment;
supervising whether the analytics logical function receives an indication of a first action;
forwarding the indication of the first action to the service consumer if the analytics logical function receives the indication of the first action;
checking whether the analytics logical function receives an information that the service consumer enforced a second action on the environment in response to the forwarding the indication of the first action;
evaluating the environment to obtain a second state of the environment if the analytics logical function receives the information that the service consumer enforced the second action on the environment;
informing the model training logical function on the second state of the environment.

53. The apparatus according to claim 52, wherein
the indication of the first action indicates plural actions which the service consumer may enforce on the environment and a respective expected reward for each of the plural actions;
the information that the service consumer enforced the second action on the environment comprises an information which of the plural actions is enforced by the service consumer; and the instructions, when executed by the one or more processors, further cause the apparatus to perform
informing the model training logical function on the second action which is enforced by the service consumer.

54. The apparatus according to claim 52, wherein the instructions, when executed by the one or more processors, further cause the apparatus to perform
comparing the first state and the second state;
deriving a reward feedback based on the comparison of the first state and the second state;
informing the model training logical function on the reward feedback.

55. The apparatus according to claim 54, wherein the instructions, when executed by the one or more processors, cause the apparatus to perform the deriving the reward feedback by:
either subjecting the comparison of the first state and the second state to a reward function to obtain a reward, wherein the reward is equal to the reward feedback;
or subjecting the comparison of the first state and the second state to the reward function to obtain the reward and mapping the reward to a respective one of plural predefined values of the reward feedback.

56. The apparatus according to claim 52, wherein the instructions, when executed by the one or more processors, further cause the apparatus to perform
informing the service consumer on the first state of the environment and on the second state of the environment.

57. The apparatus according to claim 52, wherein the instructions, when executed by the one or more processors, further cause the apparatus to perform
checking whether the analytics logical function receives an information that the service consumer agrees to join the reinforcement learning training;
inhibiting the informing the model training logical function on the first state of the environment if the analytics logical function does not receive the information that the service consumer agrees to join the reinforcement learning training.

58. The apparatus according to claim 52, wherein either
the first action is the same as the second action, or
the first action is different from the second action.

59. The apparatus according to claim 52, wherein the instructions, when executed by the one or more processors, further cause the apparatus to perform
monitoring whether the analytics logical function receives an indication of the second action in response to the forwarding the indication of the first action to the service consumer;
providing the indication of the second action to the model training logical function if the analytics logical function receives the indication of the second action.

60. Apparatus comprising:
one or more processors and memory storing instructions that, when executed by the one or more processors, cause the apparatus to perform:
monitoring whether a model training logical function receives a first state of an environment on which a reinforcement learning training is to be performed;
performing machine learning model forward propagation on a first model of the environment having the first state for each of plural actions to obtain a respective expected reward for each of the plural actions if the model training logical function receives the first state of the environment;
selecting a first one of the plural actions taking into account the expected rewards;
informing a service consumer on the first one of the plural actions;
supervising whether the model training logical function receives a reinforcement learning training result information after the informing the service consumer on the first one of the plural actions, wherein the reinforcement learning training result information comprises a second state of the environment, a reward feedback, and an indication of a second action;
conducting a machine learning model backward propagation on the first model of the environment having the second state for the second action and the reward feedback to obtain a second model of the environment if the model training logical function receives the reinforcement learning training result information.

61. The apparatus according to claim 60, wherein either
the first one of the plural actions is the same as the second action; or
the first one of the plural actions is different from the second action.

62. The apparatus according to claim 60, wherein the instructions, when executed by the one or more processors, further cause the apparatus to perform
monitoring whether the model training logical function receives an information that the service consumer agrees to join the reinforcement learning training;
inhibiting the performing the machine learning model forward propagation if the model training logical function does not receive the information that the service consumer agrees to join the reinforcement learning training.

63. The apparatus according to claim 62, wherein the information that the service consumer agrees to join the reinforcement learning training comprises the indication of the second action.

64. The apparatus according to claim 60, wherein the instructions, when executed by the one or more processors, further cause the apparatus to perform
checking whether the second model is considered to be sufficiently trained;
if the second model is considered to be sufficiently trained:
monitoring whether the model training logical function receives a third state of the environment;
performing machine learning model forward propagation on the second model of the environment having the third state for each of the plural actions to obtain a respective expected reward for each of the plural actions if the model training logical function receives the third state of the environment;
selecting a third one of the plural actions for which the expected reward is highest among the expected rewards for the plural actions;
instructing the service consumer to perform the third one of the plural actions.
